(19) United States
(12) Patent Application Publication
(10) Pub. No.: US 2024/0153253 A1
(43) Pub. Date: May 9, 2024

(54) METHOD AND PROGRAM FOR GENERATING TRAINED MODEL FOR INSPECTING NUMBER OF OBJECTS

(71) Applicant: YAMAHA HATSUDOKI KABUSHIKI KAISHA, Iwata-shi, Shizuoka-ken (JP)

(72) Inventor: Kunimune KOMAIKE, Shizuoka (JP)

(73) Assignee: YAMAHA HATSUDOKI KABUSHIKI KAISHA, Iwata-shi, Shizuoka-ken (JP)

(21) Appl. No.: 18/550,393

(22) PCT Filed: Mar. 29, 2021
(86) PCT No.: PCT/JP2021/013359

§ 371 Date: Sep. 13, 2023

(51) Int. Cl. G06V 10/774; G06M 11/00; G06T 7/00; G06T 7/73; G06T 15/04; G06V 10/74

(52) U.S. Cl. CPC G06V 10/774; G06M 11/00; G06T 7/001; G06T 7/74; G06T 15/04; G06V 10/761; G06T 2207/20081; G06T 2207/30242

(57) ABSTRACT

A learning model generation method is a method for generating a learning model for use in machine learning to automatically examine the number of target objects accommodated in a container. The method includes: by a device that generates the learning model, a step of inputting model data which represents a shape of the container and a shape of a target object in an image; a step of creating, by using the model data, a plurality of unit formative assemblies each having a plurality of target objects arranged in a specific array and arranging the unit formative assemblies in a container area corresponding to the container in a specific formation to create shape image data of the container accommodating the target objects at a specific density; and a step of creating training image data for use in establishing the learning model by applying processing of giving a real texture of each of the container and the target object to the shape image data.

### CROSS-REFERENCE TO RELATED APPLICATION

This application is a National Stage of International Patent Application No. PCT/JP2021/013359, filed Mar. 29, 2021, the entire content of which is incorporated herein by reference.

### BACKGROUND

### Technical Field

The present disclosure relates to a method and a program for generating a learning model for use in machine learning to automatically examine the number of target objects.

### Background Art

An examination of checking the number of components or target objects accommodated in a tray or container, or an examination of confirming whether a required number of components are accommodated in the container is conducted to allow a robot or the like to pick up each component in the tray on some occasions. On such an occasion, an adoptable way is to photograph the tray accommodating the components and automatically specify the number of components in the tray by performing image recognition. Many images of the tray accommodating components may be subjected to machine learning as training image data to generate a learning model for the examination with an aim of reliable performance of the image recognition.

Japanese Unexamined Patent Publication No. 2020-126414 discloses a technology of creating, on the basis of an actual image captured by actually photographing a tray accommodating components, a plurality of pieces of training image data for machine learning by changing a position of each component and differentiating an orientation of the component. However, the actual image does not always clearly reflect each component in a recognizable manner. For instance, in the image recognition of each component through edge extraction, recognition performance reduces when an edge of the component is obscure or adjacent components overlap each other. Therefore, execution of the machine learning using the training image data created on the basis of the actual image under the circumstances may lead to a failure in acquisition of a reliable learning model.

### SUMMARY

The present disclosure provides a learning model generation method for reliably generating a learning model for use in machine learning to examine the number of target objects.

A learning model generation method for examining the number of target objects according to one aspect of the present disclosure is a method for generating a learning model for use in machine learning to automatically examine the number of target objects accommodated in a container. The method includes: by a device that generates the learning model, a step of inputting model data which represents a shape of the container and a shape of a target object in an image; a step of creating, by using the model data, a plurality of unit formative assemblies each having a plurality of target objects arranged in a specific array and arranging the unit formative assemblies in a container area corresponding to the container in a specific formation to create shape image data of the container accommodating the target objects at a specific density; and a step of creating training image data for use in establishing the learning model by applying processing of giving a real texture of each of the container and the target object to the shape image data.

A learning model generation program for examining the number of target objects according to another aspect of the present disclosure is a program for causing a predetermined learning model generation device to generate a learning model for use in machine learning to automatically examine the number of target objects accommodated in a container. The program includes: causing the learning model generation device to execute: a step of receiving model data which represents a shape of the container and a shape of a target object in an image; a step of creating, by using the model data, a plurality of unit formative assemblies each having a plurality of target objects arranged in a specific array and arranging the unit formative assemblies in a container area corresponding to the container in a specific formation to create shape image data of the container accommodating the target objects at a specific density; and a step of creating training image data for use in establishing the learning model by applying processing of giving a real texture of each of the container and the target object to the shape image data.

### BRIEF DESCRIPTION OF THE DRAWINGS

FIG. 1 is a block diagram showing a configuration of an automatic number examining system in a first embodiment adopting a method for generating a learning model according to the present disclosure;

FIG. 2 is a block diagram showing an operative configuration of a training image data creator;

FIG. 3 is a flowchart showing an outline of a process of creating training image data in the first embodiment;

FIG. 4 is a schematic view showing a state of executing the process of creating the training image data;

FIG. 5A and FIG. 5B are an illustration of a state of creating a unit formative assembly at a stage 1 shown in FIG. 3;

FIG. 6A and FIG. 6B are an illustration of executing freefall in the creation of the unit formative assembly;

FIG. 7A to FIG. 7E are an illustration of a state of executing arrangement of unit formative assemblies in a mixture area at a stage 2 in FIG. 3;

FIG. 8 is an illustration of another example of arrangement of the unit formative assemblies in the mixture area;

FIGS. 9A to 9C are an illustration of a state of executing arrangement of the mixture area in a container area at a stage 3 shown in FIG. 3;

FIGS. 10A to 10E are an illustration of a specific example of the training image data;

FIG. 11 is a flowchart showing the process of creating the training image data in the first embodiment;

FIG. 12 is a block diagram showing a configuration of an automatic number examining system in a second embodiment;

FIG. 13A and FIG. 13B are an illustration of a state of determining a similarity between a composite training image and an actual image;

FIG. 14 is a schematic view showing a state of executing a process of creating training image data in a third embodiment;

FIG. 15A and FIG. 15B are an illustration of a state of executing arrangement of a unit formative assembly in a fourth embodiment;

FIG. 16 is a flowchart showing a process of creating training image data in the fourth embodiment; and

FIGS. 17A to 17E are an explanatory view explaining a defect or failure in the creation of training image data based on an actual image.

### DETAILED DESCRIPTION

Hereinafter, embodiments of a method for generating a learning model to examine the number of target objects according to the present disclosure will be described in detail with reference to the accompanying drawings. A learning model to be generated in the present disclosure is for use in a predetermined processor to automatically conduct, by performing image recognition, an examination of grasping the number of target objects accommodated in a container or an examination to determine whether a required number of target objects are accommodated in the container. An image of the target objects accommodated in the container in various arrays is subjected to the machine learning as training image data to generate a learning model for the number examination. In the present disclosure, not an actual image of the container accommodating the target objects, but a composite image created on the basis of shape image data like CAD data is used as the training image.

An object recognizable as an individual in a captured image can be an examination target object in the present disclosure without any particular limitation. Further, a container which can accommodate a required number of target objects and has an opening for allowing all the accommodated target objects to be photographed is available without any particular limitation. Examples of the target objects include: components, such as machine components and electronic components; final products each having a small size; agricultural products, such as cereals, fruits, vegetables, and root vegetables; and processed foods. Examples of the container include; a storage box; a tray; a flatware; and other containers, each having an opening on the top thereof.

### First Embodiment/Configuration of an Automatic Number Examining System

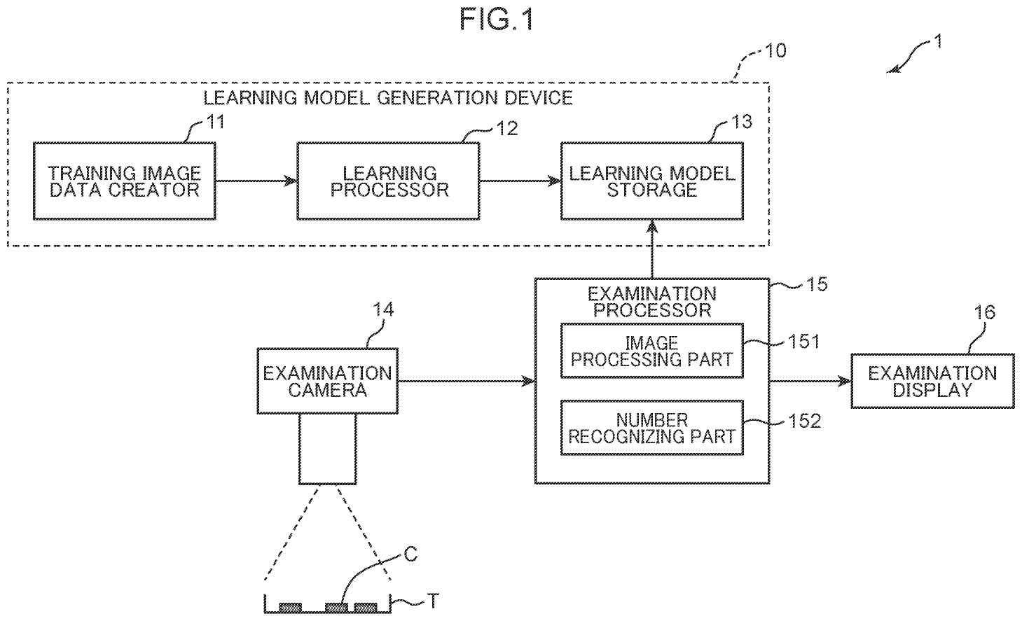

FIG. 1 is a block diagram showing a configuration of an automatic number examining system 1 in a first embodiment adopting a method for generating a learning model according to the present disclosure. The drawing exemplifies the automatic number examining system 1 that conducts an examination of grasping the number of components C (target objects) accommodated in a container T, such as a component tray. After the examination, each component C in the container T is picked up by, for example, a robot hand.

The automatic number examining system 1 includes a learning model generation device 10, an examination camera 14, an examination processor 15, and an examination display 16. The learning model generation device 10 executes learning with a predetermined machine learning algorithm by using, as training image data, a composite image of the container T accommodating the components C in various arrays, and generates a learning model. The examination camera 14 captures an actual image of the container T accommodating the components C whose number is to be examined.

The examination processor 15 detects the number of components C accommodated in the container T shown in the actual image captured by the examination camera 14, by applying the learning model generated by the learning model generation device 10 to the actual image. The examination processor 15 includes an image processing part 151 and a number recognizing part 152. The image processing part 151 applies, to actual image data captured by the examination camera 14, necessary image processing, such as modification of contrast or brightness, noise removal, enlarging or reduction, edge enhancement, and trimming. The image processing part 151 may be excludable when no special image processing is required. The number recognizing part 152 applies the learning model to the actual image data subjected to the image processing, and detects the number of objects recognized as the components C in the actual image data. The examination display 16 displays the number of components C recognized by the examination processor 15, or displays a result of success or failure based on the number.

The learning model generation device 10 includes a training image data creator 11, a learning processor 12, and a learning model storage 13. The training image data creator 11 creates various kinds of training image data to be learning materials by image composition. The learning processor 12 executes supervised learning with a machine learning algorithm by using the various kinds of training image data created by the training image data creator 11 to generate a learning model. Deep learning like the CNN (Convolution Neural Network) which is machine learning using a neural network is adoptable as the machine learning algorithm. The learning model storage 13 stores the learning model generated by the learning processor 12.

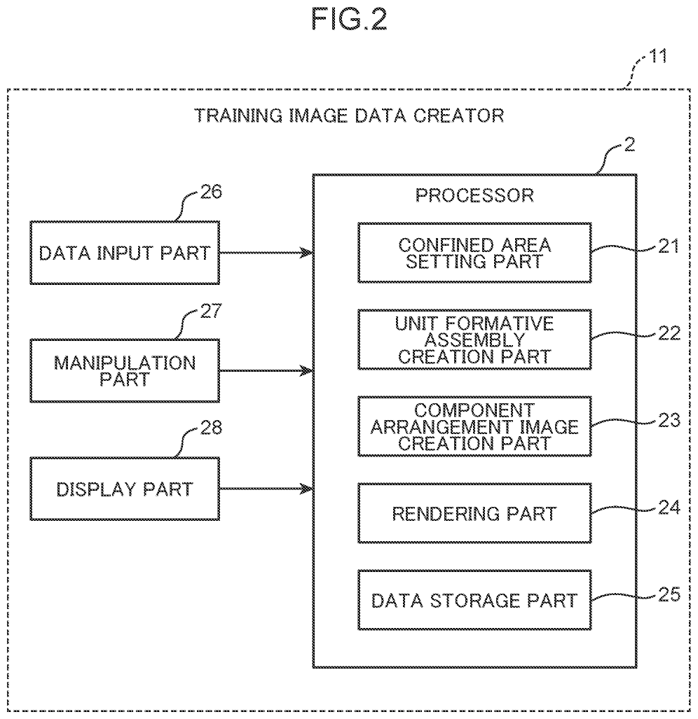

FIG. 2 is a block diagram showing an operative configuration of the training image data creator 11. The training image data creator 11 includes a processor 2, a data input part 26, a manipulation part 27, and a display part 28. For instance, the processor 2 serves as a main body of a personal computer, the manipulation part 27 serves as a keyboard of the personal computer, and the display part 28 serves as a monitor of the personal computer. Software to be installed in the personal computer corresponds to a learning model generation program for examining the number of target objects according to the present disclosure.

The data input part 26 inputs, into the processor 2, model data representing a three-dimensional shape of each of the component C and the container T in an image to create a composite image. For instance, the data input part 26 indicates another computer that creates three-dimensional CAD data, or a server that stores the three-dimensional CAD data. The manipulation part 27 receives a necessary manipulation from an operator to the processor 2 in creating the composite image to be training image data. The display part 28 displays the created composite image.

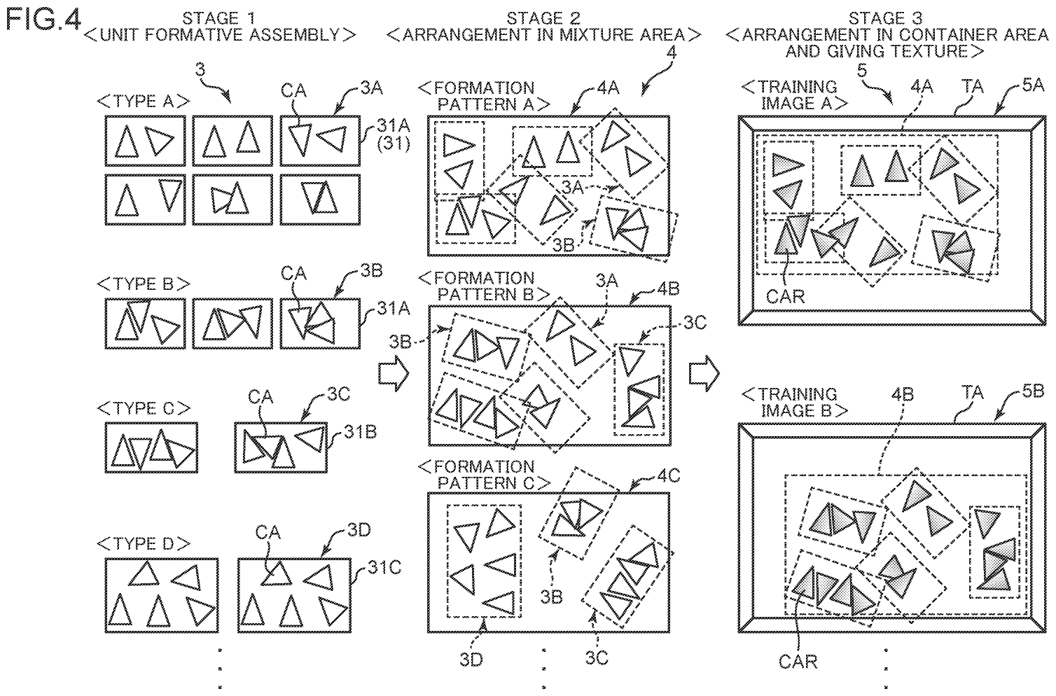

The processor 2 operatively has a confined area setting part 21, a unit formative assembly creation part 22, a component arrangement image creation part 23, a rendering part 24, and a data storage part 25. The confined area setting part 21 creates a confined area to be a unit area for accommodating a specific number of components C created from model data. The unit formative assembly creation part 22 performs a processing for inducing the specific number of components C to freefall into the confined area in accordance with a physical simulation. Execution of the freefall leads to creation of a unit formative assembly 3 (FIG. 4) having the specific number of components arranged in the confined area in a specific array.

The component arrangement image creation part 23 creates shape image data of the container T accommodating the components C at a specific density by arranging unit formative assemblies 3 in a container area corresponding to the container T in a specific formation. The rendering part 24 creates a composite image by applying processing of giving a real texture of each of the container T and the component C to the shape image data. Data of the composite image serves as training image data to be used in establishing the learning model by the learning processor 12. The data storage part 25 stores information indicating a position of each component C in the shape image data as true data indicating the position of the component C in the training image data.

[Overall Sequence of Creating the Training Image Data]

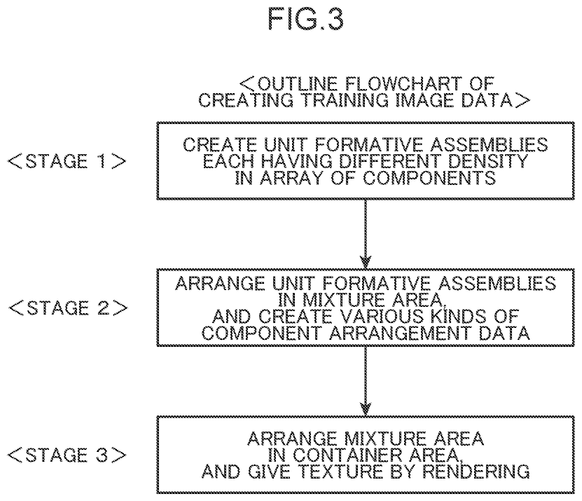

FIG. 3 is a flowchart showing an outline of a process of creating training image data in the first embodiment. FIG. 4 is a schematic view showing a state of executing the process of creating the training image data. The process of creating the training image data in the embodiment includes three stages of: creating a plurality of unit formative assemblies 3 (stage 1); arranging the unit formative assemblies 3 in a mixture area 4 (stage 2); and arranging the mixture area 4 in the container area and giving a texture, i.e., executing finishing to obtain a training image 5 (stage 3).

Each unit formative assembly 3 created at the stage 1 includes a component CA created with three-dimensional CAD data, and a confined area 31 restricting an arrangement area of the component. At the stage 1, a plurality of unit formative assemblies 3 each having a specified number of components CA arranged in a specific array different from an array in another assembly is created. Specifically, each of the created unit formative assemblies 3 has a different size of the confined area 31, a different number of components CA, and a different arrangement direction of the component CA. It is noted here that the confined area 31 has a size which is smaller than the size of a container area TA corresponding to the container T.

FIG. 4 exemplifies four types, i.e., types A to D, of unit formative assemblies 3A to 3D in plural. Each unit formative assembly 3A in the type A has two components CA randomly arranged in a confined area 31A having a predetermined size. Each unit formative assembly 3B in the type B has three components CA randomly arranged in a confined area 31A having the same size as the confined area in the type A. In other words, the components CA in the unit formative assembly 3B are arranged at a higher density than a density in the unit formative assembly 3A. Each unit formative assembly 3C in the type C has four components CA randomly arranged in a confined area 31B which is larger than the confined area 31A. Each unit formative assembly 3D in the type D has five components CA randomly arranged in a confined area 31C which is further larger than the confined area 31B.

At the stage 2, the unit formative assemblies 3 created at the stage 1 are combined in a specific manner and arranged in the mixture area 4 to diversify arrangements of the components CA. The mixture area 4 is set to a size which is equal to or smaller than the container area TA and larger than the confined area 31. Concerning the unit formative assemblies 3A to 3D, a plurality of mixture areas 4 each having a different number of arranged unit formative assemblies 3, a different formation thereof, a different arrangement direction thereof, and a different coarseness and fineness state thereof is created.

FIG. 4 exemplifies three kinds of mixture areas 4A to 4C respectively in formation patterns A to C. The mixture area 4A in the formation pattern A includes a combination of the unit formative assemblies 3A and 3B in the types A and B to form an arrangement pattern of components CA. The mixture area 4B in the formation pattern B includes a combination of the unit formative assemblies 3A, 3B, and 3C in the types A, B, and C to form an arrangement pattern of components CA. The mixture area 4C in the formation pattern C includes a combination of the unit formative assemblies 3B, 3C, and 3D in the types B, C, and D to form an arrangement pattern of components CA. Employing this way of forming the mixture area 4 enables creation of composite image data showing densely arranged components CA in a mixture area 4 as well as composite image data showing uniformly dispersed components CA in a mixture area. This consequently achieves creation of composite image data showing components CA arranged at various densities or coarseness and fineness degrees.

At the stage 3, each mixture area 4 formed at the stage 2 is arranged in the container area TA at a specific position in a specific direction to create shape image data. Further, the shape image data is subjected to rendering processing to be given a texture matching a real texture of each of the component C and the container T. The processing at the stage 3 results in creating data of the training image 5 including an image comparable to the actual image captured by photographing the container T accommodating the component C.

FIG. 4 exemplifies two kinds of training images 5A and 5B. The training image 5A is acquired by applying the rendering processing of giving the texture to shape image data created by arranging the mixture area 4A in the formation pattern A at an upper left position in the container area TA. The training image 5B is acquired by applying the rendering processing to shape image data created by arranging the mixture area 4B in the formation pattern B at a lower right position in the container area TA. Each component CA included in the shape image data is processed to a component CAR having the real texture in each of the training images 5A, 5B. The container area TA is given a real texture of the container T as well.

[Details of Processing at Each Stage]

Hereinafter, a specific example of the processing executed at each of the stages 1 to 3 will be described. A physical simulator is used for each processing.

<Stage 1>

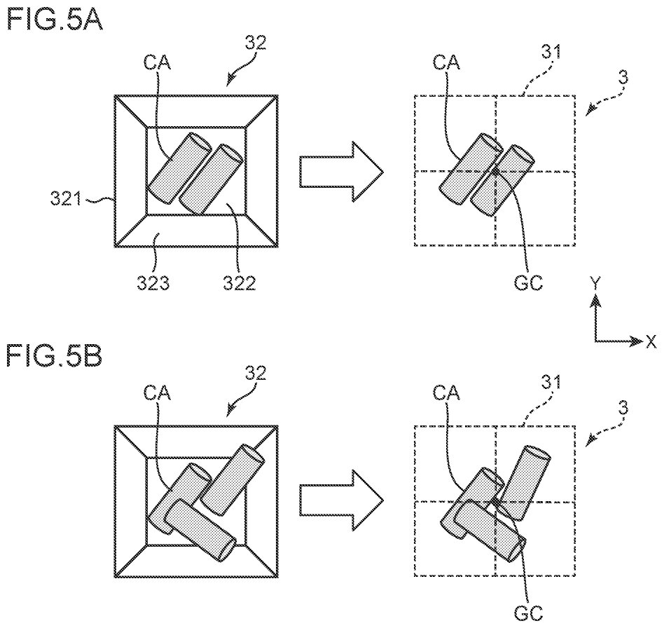

FIG. 5A and FIG. 5B are an illustration of a state of creating a unit formative assembly 3 at the stage 1 shown in FIG. 3. The confined area 31 is represented as a confinement container 32 on the physical simulator. The confinement container 32 has four side sections 321 extending in XY directions, a bottom wall 322 located below the side sections 321, and a tapered section 323 between the corresponding side section 321 and the bottom wall 322. A size of the confined area 31 in each of the XY directions can be automatically set or manually set with the following equations:

X=size of the component CA in a long side direction×expansion coefficient β; and

Y=size of the component CA in a short side direction×the number of components CA×expansion coefficient β.

The expansion coefficient β in each equation serves as a coefficient for setting a density of components CA per unit area in the confined area 31. The expansion coefficient β may be set, for example, in increments of 0.1 within a range from 1.0 to 2.0. Each component CA reflects a tolerance of the corresponding actual component C. In a case where the component CA has a square shape, multiplying a size of one side of the square by the expansion coefficient β can define a size of the component in each of the XY directions. In a case where the component CA has a circular shape, multiplying a diameter thereof by the expansion coefficient β can define a size of the component in each of the XY directions.

The unit formative assembly 3 is created by arranging a specific number of components CA in the confined area 31 in a specific array. Adoptable ways of the arrangement in the specific array in the embodiment include a way of inducing the specific number of components CA to freefall into the confined area 31 or the confinement container 32 in accordance with the physical simulation. The arrangement of the components CA in this array through the freefall aims at preventing the components CA from being arranged in a manner defying physical laws. However, the setting of the confined area 31 restricts chaotic rolling of the component CA after the freefall, and regulates an area for arrangement of the component CA in a specific array to come to the confined area 31. This facilitates: creation of a group of unit formative assemblies 3 (e.g., a group of the unit formative assemblies 3A in FIG. 4) each having the same arrangement density of components CA per unit area in different postures; and creation of another group of unit formative assemblies 3 (e.g., a group of the unit formative assemblies 3A and 3B) respectively having different densities of components in different postures. Besides, a frame of each unit formative assembly 3 is stylized, and thus, subsequent arrangement of the assembly in the mixture area 4 is also facilitated.

When a component CA having a specific posture at a certain height level is induced to freefall into the confinement container 32, the component CA can have various postures in the confinement container 32. FIG. 5A exemplifies two components CA induced to have freefallen into the confinement container 32. In this example, the two components CA are accommodated within a range of the bottom wall 322 of the confinement container 32 thereon. FIG. 5B exemplifies three components CA induced to have freefallen into a confinement container 32 having the same size. In this example, some portions of the components CA enter tapered sections 323 in an unnatural state. After the freefall, the confinement container 32 is removed on the physical simulator.

The right view in each of FIG. 5A and FIG. 5B shows an arrangement of the components CA in the confined area 31 after the removal of the confinement container 32. The components CA contained in the confined area 31 form a component group constituting one unit formative assembly 3. No change is seen in the postures of the components CA in the confined area 31 in FIG. 5A before and after the removal of the confinement container 32. By contrast, a change is seen in the posture of a part of the components CA in the confined area 31 in FIG. 5B before and after the removal of the confinement container 32. The posture of the component may change as mentioned above. Thus, a predetermined time after the removal of the confinement container 32 is defined as a standby time to wait for stabilization of such a change in the position or posture of each component CA. After a lapse of the standby time, the center of the confined area 31 is defined as a component group center GC in the corresponding unit formative assembly 3, and data about the position and the posture of each component CA relative to the component group center GC is stored.

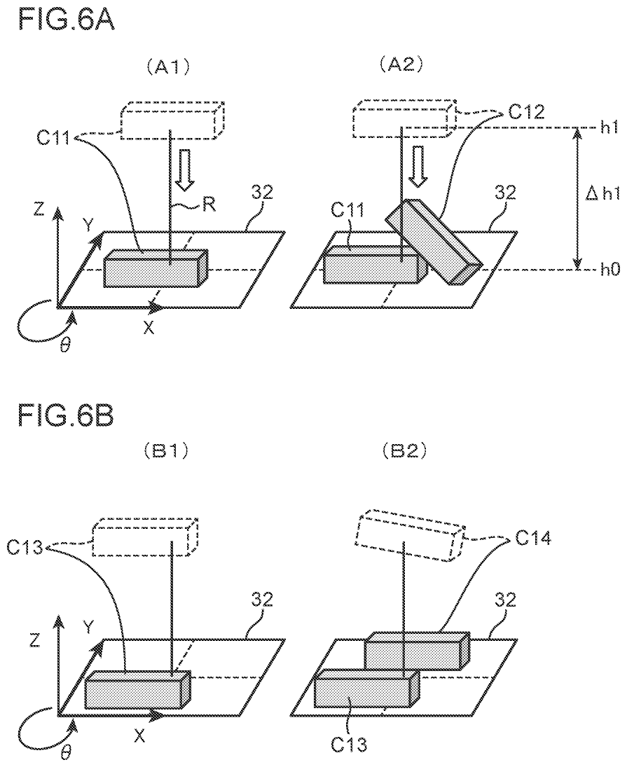

FIG. 6A and FIG. 6B are a schematic view showing an execution example of freefall of a component CA. In freefall of a plurality of components CA into a single confinement container 32, the components CA may be started to freefall in the same state or in different states from each other. FIG. 6A shows an example of inducing two components C11 and C12 to freefall in the same rotation state and the same posture from the same height level. It is noted here that each of the components C11 and C12 rotates about a Z-axis, and the posture thereof is in a rotation about an X-axis and/or a Y-axis.

The component C11 illustrated in (A1) in FIG. 6A is induced to freefall from a fall start height level h1 which is higher than a reference height level h0 on a plane of the confinement container 32 (confined area 31) by Δh1 along a fall axis R extending vertically upward from the component group center GC. The component C11 is rotatable about the Z-axis with the longitudinal direction of the component C11 being along the X-axis, but is not rotatable about the X-axis and the Y-axis. The component C12 illustrated in (A2) in the drawing is induced to freefall from the same fall start height level h1 in the same posture while rotating along the fall axis R in the same manner as the component C11. The component C12 is in a state of leaning onto the component C11 on the confinement container 32.

FIG. 6B shows an example of inducing two components C13 and C14 to freefall from the same fall start height level but different positions in different postures. The component C13 illustrated in (B1) in FIG. 6B is induced to freefall into a confinement container 32 from a position shifted from the fall axis R in the same rotation state and the same posture as those of the aforementioned component C11. By contrast, the component C14 illustrated in (B2) in the drawing is induced to freefall into the confinement container 32 from a position different from the position of the component C13 and in a posture rotated about the Y-axis unlike the component C13. The component C13 and the component C14 lie adjacently at different positions on the confinement container 32.

As described heretofore, the way of inducing the components CA to freefall in accordance with the physical simulation is employed in the embodiment. This way is less likely to cause specific dense arrangement of components in creation of many unit formative assemblies 3 each having a specific number of components CA arranged in the confined area 31 in a specific array. This consequently enables creation of unit formative assemblies 3 each allowing for various postures in respective confined areas 31, and creation of shape image data having various densities, or coarseness and fineness degrees of components CA.

<Stage 2>

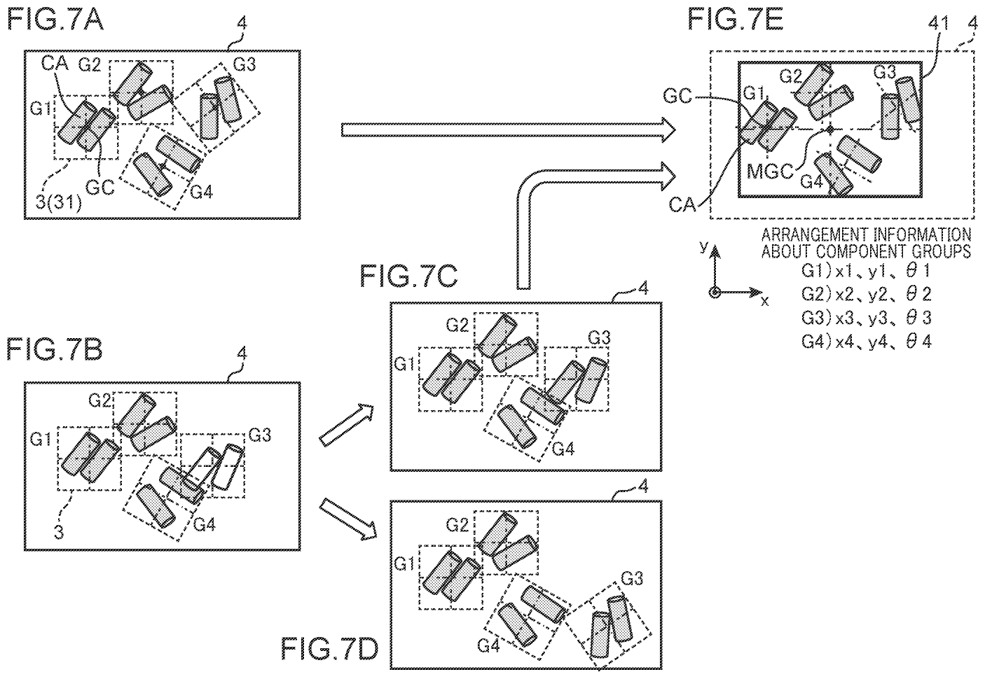

FIGS. 7A to 7E are an illustration of a state of executing arrangement of each unit formative assembly 3 in the mixture area 4 at the stage 2 in FIG. 3. The mixture area 4 is set to be equal to or smaller than the container area TA on the physical simulator. The size of the mixture area 4 is, for example, automatically set with the following equation:

size of the mixture area 4=size of the container area TA×reduction coefficient α.

The reduction coefficient α is a coefficient for setting the mixture area 4 to a size suitable for arrangement of a plurality of unit formative assemblies 3 in the container area TA. For instance, when the container area TA has a rectangular shape with its sides extending in the XY directions, the mixture area 4 is set to a size having a side length in each of the XY directions obtained by multiplying the side length in each of the XY directions of the container area by the reduction coefficient α. The reduction coefficient α is settable within a range of, for example, 0.8 to 1.0.

The unit formative assemblies 3 created at the stage 1 are arranged in the mixture area 4 in a specific formation. FIG. 7A exemplifies the mixture area 4 including four unit formative assemblies 3 arranged therein. The four unit formative assemblies 3 are respectively called component groups G1, G2, G3, and G4. Arrangement of each of the component groups G1 to G4 is determined with reference to a corresponding component group center GC. First, an arrangement coordinate of the component group center GC of the component group G1 in the mixture area 4 is appropriately set and the component group G1 is appropriately rotated about the component group center GC to define the arrangement of the component group. The arrangement of the component group G1 is set to allow each component CA to come within the mixture area 4 without going out therefrom. However, the confined area 31 defining a frame for the arrangement of the component group G1 may be out of the mixture area 4.

Next, the component group G2 is arranged in the mixture area 4. Similarly, an arrangement coordinate of the component group center GC of the component group G2 in the mixture area 4 and a rotation thereof are appropriately set. Thereafter, a contact check is executed to check whether a component CA in the component group G2 is in contact with a precedingly arranged component CA in the component group G1. As exemplified in FIG. 5B, such contact between components CA is taken into consideration in the arrangement of unit formative assemblies 3. Under the consideration, the stage of arranging the unit formative assemblies 3 in the mixture area 4 avoids an occurrence of contact between the component groups G1 to G4 for simplification of the processing.

When no occurrence of contact is confirmed as a result of the contact check, the component group G3 is subsequently arranged in the mixture area 4. Another contact check is executed, and the component group G4 is then arranged in the mixture area 4. FIG. 7A exemplifies an arrangement of the component groups G1 to G4 in which a component CA in one group is not in contact with a component in another group. Here, contact between confined areas 31 is acceptable.

FIG. 7B exemplifies an occurrence of contact between some components CA in the component groups G1 to G4 arranged in the mixture area 4. Specifically, a certain component CA in the component group G3 and a certain component CA in the component group G4 are in contact with each other. In the occurrence of the contact, one of the following changes (a) and (b) is made:
(a) shifting the arrangement coordinate of the component group center GC of either the component group G3 or the component group G4, or rotating the component group about the component group center GC to avoid the contact; and
(b) cancelling the arrangement coordinate of the component group center GC of either the component group G3 or the component group G4, and newly setting another arrangement coordinate and another rotation.

FIG. 7C exemplifies the change (a) of shifting the arrangement coordinate of the component group G3 in an upper right direction to avoid the contact between the component group G3 and the component group G4. Instead of the example shown in FIG. 7C, the arrangement coordinate of the component group G4 may be shifted, or the component group G3 or the component group G4 may be rotated about the corresponding component group center GC to avoid the contact. FIG. 7D exemplifies the change (b). The arrangement coordinate of the component group G3 as set in FIG. 7B is canceled, and another arrangement coordinate and another rotation of the component group G3 is newly set. It is matter of course that the arrangement coordinate of the component group G4 may be canceled, and another arrangement coordinate and another rotation of the component group G4 may be newly set. The sequence described above attains various arrangements of the components CA in the mixture area 4 while keeping a component arrangement relationship among the component groups G1 to G4 created at the stage 1.

Subsequently, as shown in FIG. 7E, a region including no component CA in the mixture area 4 is removed on the data. This achieves high flexibility of arrangement of the component groups G1 to G4 arranged in the mixture area 4 into the container area TA. FIG. 7E exemplifies definition of a mixture component group area 41 being a smallest rectangular area (an outermost contour) which can enclose the component groups G1 to G4, and exclusion of a region outside the mixture component group area 41. Away of excluding the region outside the outermost contour is not limited to the setting of the smallest rectangular area, and another appropriate way may be adopted for the exclusion. Alternatively, the mixture area 4 may be directly used without the exclusion operation.

Thereafter, the arrangement state of the component groups G1 to G4 in the mixture component group area 41 is stored. Specifically, a storage device stores an arrangement coordinate and a rotation angle of the corresponding component group center GC of each of the component groups G1 to G4 with reference to a mixture component group center MGC being a center coordinate of the mixture component group area 41 as a reference coordinate. Data to be stored includes values “xn, yn, and θn” respectively denoting coordinate values in an x-direction and a y-direction with reference to the mixture component group center MGC, and a rotation angle θ of the component group center GC about a z-axis.

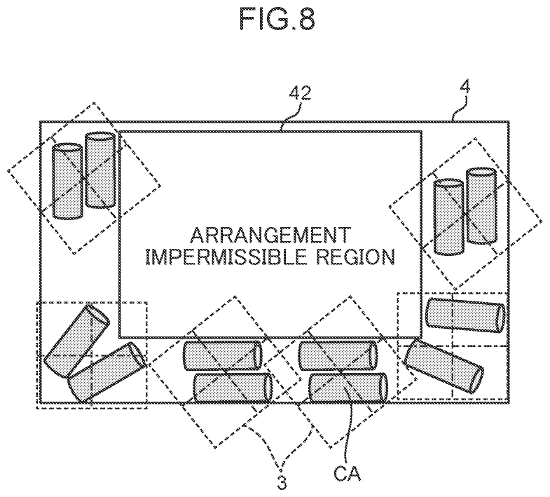

FIG. 8 is an illustration of another example of arrangement of unit formative assemblies 3 in the mixture area 4. Each of FIG. 7A to 7E exemplifies use of an entire region of the mixture area 4 as an arrangement permissible region of the unit formative assemblies 3. Instead, FIG. 8 exemplifies a setting of an arrangement impermissible region 42 in the mixture area 4 for forbidding arrangement of any unit formative assembly 3. In this example, the unit formative assemblies 3 are arranged in an arrangement permissible region in the mixture area 4 to avoid contact between each component CA and the arrangement impermissible region 42 as well as contact between components CA in the unit formative assemblies 3. In an operation of actually adding components C, the components C may be densely arranged around an edge of the container T. The setting of the arrangement impermissible region 42 contributes to creation of training image data assuming such dense arrangement.

<Stage 3>

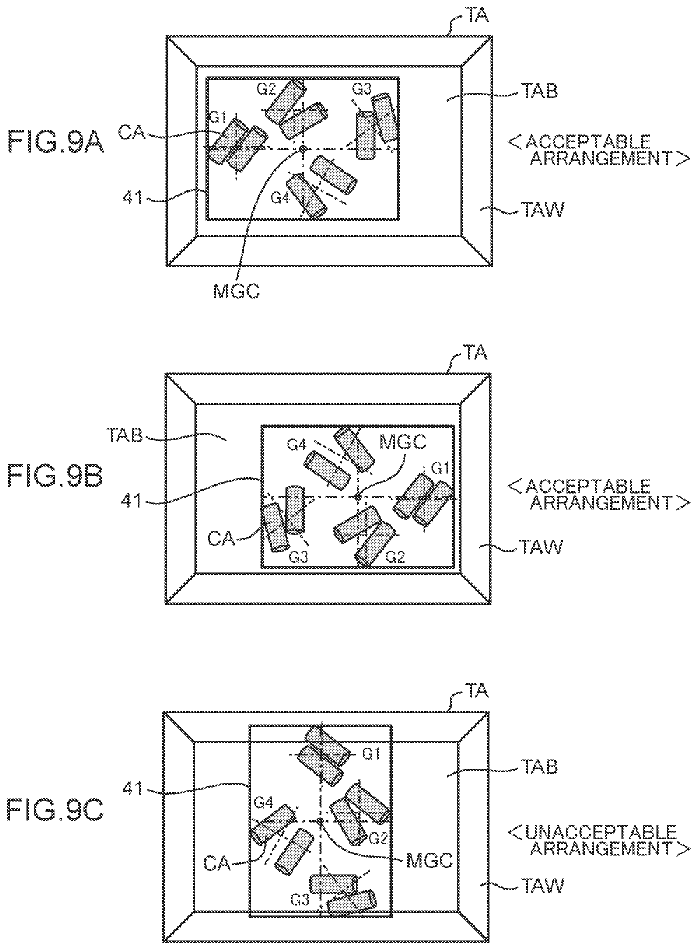

At the stage 3, arrangement of the mixture component group area 41 or the mixture area 4 formed at the stage 2 in the container area TA is executed. FIG. 9A to 9C are an illustration of a state of executing the arrangement of the mixture component group area 41 in the container area TA. The mixture component group area 41 is arranged in the container area TA by appropriately setting the arrangement coordinate (xn, yn) of the mixture component group center MGC and a rotation angle (On) about the mixture component group center MGC. However, a setting range of the arrangement coordinate indicates a range of a difference between the container area TA and the mixture component group area 41.

FIG. 9A exemplifies an arrangement of the mixture component group area 41 at an upper left position in the container area TA. FIG. 9B exemplifies an arrangement of the mixture component group area 41 at a lower right position in the container area TA. The container area TA has a side wall region TAW and a bottom wall region TAB where components are actually disposed. The mixture component group area 41 in the example in each of FIGS. 9A and 9B is within the bottom wall region TAB and thus satisfies an arrangement requirement (acceptable arrangement).

By contrast, FIG. 9C exemplifies an arrangement dissatisfying the arrangement requirement (unacceptable arrangement). An arrangement coordinate of the mixture component group center MGC of the mixture component group area 41 serves as the center of the container area TA. However, the mixture component group area 41 in the example in FIG. 9C is rotated about the center MGC at 90 degrees in the clockwise direction from the state of the mixture component group area in FIG. 9A, and thus, the component groups G1 and G3 enter the side wall region TAW. In this arrangement, the rotation angle of the mixture component group area 41 is changed, or the arrangement coordinate the mixture component group center MGC and the rotation angle thereabout are reset.

At the stage 3, subsequently, processing of giving a texture to each of the container area TA and the components CA is executed by rendering. The processing preferably adopts a physically based rendering tool. One way of the rendering processing is a setting of an optical system for photographing the container area TA including components CA arranged therein. The setting of the photographic optical system is performed in consideration of a case where the examination camera 14 (FIG. 1) photographs the container area TA actually including components C. In other words, a pseudo-camera imitating the examination camera 14 and pseudo-lighting assuming an environment of the examination chamber are set.

For the pseudo-camera, parameters including exposure (diaphragm, a shutter speed, and an ISO sensitivity), a depth of field, a view angle, and a camera arrangement angle are set. The actual photographing by the examination camera 14 is performed under the presumption that images having different focus degrees may be captured or images captured in different directions may be acquired, and thus uniform images are not acquirable. Thus, a variation range is set for each parameter which is likely to fluctuate and give influence on an image quality among the aforementioned parameters. It is noted here that a variation value is within a range conforming to the physical laws. This setting can cover an image acquirable by the examination camera 14, and succeeds in creation of training image data suitable for an actual situation.

Concerning the pseudo-lighting, parameters including a type of a lighting device to be used, brightness, a hue, a lighting direction, a reflection condition in the examination chamber are set. A lighting condition also may fluctuate due to various factors. For instance, the lighting condition temporarily fluctuates due to a shadow made when an operator passes around a photographing position for the examination camera 14. For this case, a variation range is set for each parameter which is likely to fluctuate among the aforementioned parameters.

Another way of the rendering processing is a setting of a material of each of the component CA and the container area TA. For instance, when an actual component C is a metal bolt, parameters including metallic luster, reflection from projections and protrusions of a screw part, and roughness are set. Parameters including a material quality, a color, and surface luster of an actual container T are set for the component CA as well. The setting of the material leads to adjustment of the texture of each of the component CA and the container area TA. The real texture of each of the component C and the container T involves a variation, and thus, a variation range is set for the material quality parameters.

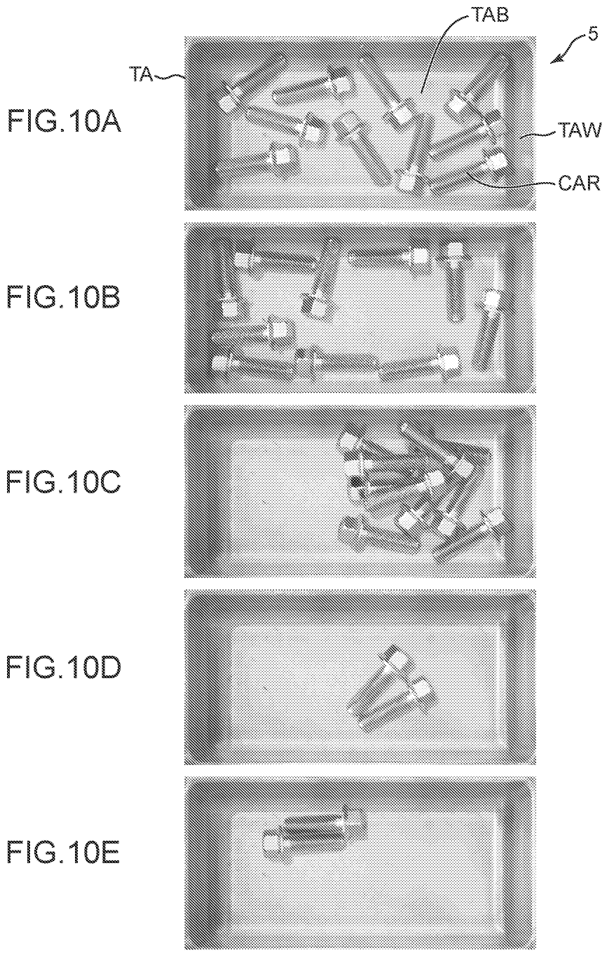

When the setting of rendering for the component CA and the container area TA is completed, physically based rendering is executed to create a training image 5 and training image data thereof is stored. FIGS. 10A to 10E are an illustration of a specific example of the training image 5. A plurality of training images 5 each formed of a composite image including a plurality of components CAR arranged on the bottom wall region TAB of the container area TA is created with a different number of components in different arrangement arrays, each of the components CAR being given its corresponding texture, the container area TA being given its corresponding texture.

FIG. 10A shows a composite image including components CAR uniformly arranged in the bottom wall region TAB of the container area TA. FIG. 10B shows a composite image including components CAR arranged along the side wall region TAW. FIG. 10C shows a composite image including components CAR arranged densely on a substantially half surface of the bottom wall region TAB. Each of FIGS. 10D and 10E shows a composite image including a pair of components CAR arranged adjacent to each other on the bottom wall region TAB. The physically based rendering is executed only after unit formative assemblies 3 and a corresponding mixture area 4 are created and formed to diversify component arrangements. This consequently achieves creation of training images 5 conforming to the physical laws in a wide variety of component arrangements.

[Sequence of the Process of Creating Training Image Data]

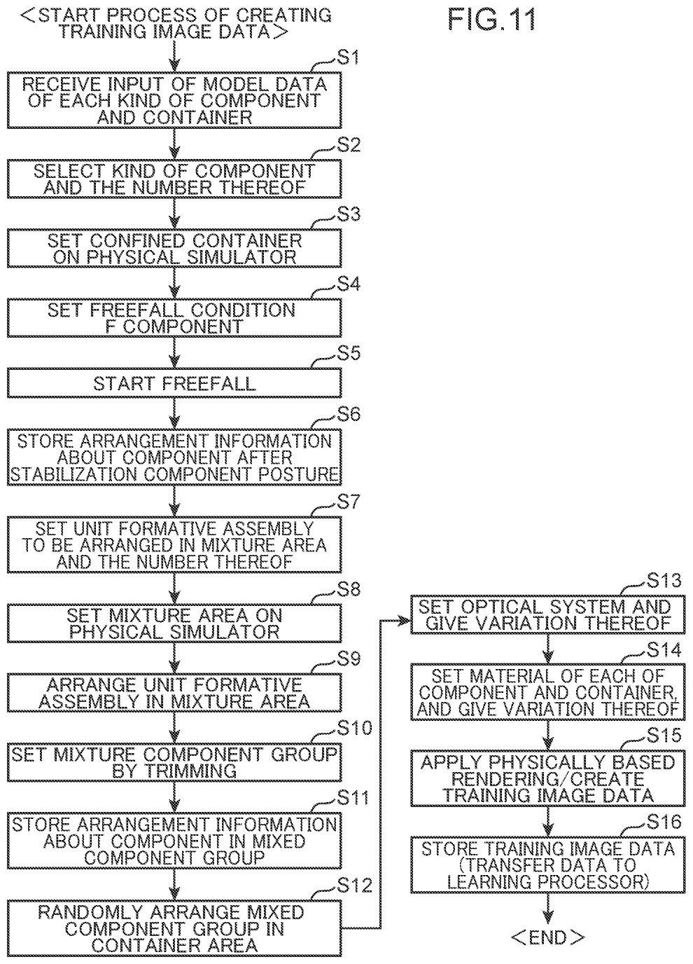

FIG. 11 is a flowchart showing the process of creating training image data to be executed by the training image data creator 11 shown in FIG. 2 in the first embodiment. The processor 2 in the training image data creator 11 receives, from the data input part 26, an input of model data representing a three-dimensional shape of each kind of the component C and the container T in an image for creating a composite image to be a training image 5 (step S1). The model data is input to the processor 2, for example, in a CAD file format.

Subsequently, the unit formative assembly creation part 22 selects a kind of and the number of components CA constituting a unit formative assembly 3 (FIG. 4) to be created by the physical simulator (step S2). Meanwhile, the confined area setting part 21 sets a confined area 31 having a required size in each of the XY directions by using long and short side directional sizes of the selected component CA and the expansion coefficient β as described above. The confined area setting part 21 further generates, on the basis of the confined area 31, a confinement container 32 (FIG. 5) on the physical simulator (step S3).

Next, the unit formative assembly creation part 22 sets a freefall condition of the component CA selected in step S2 to freefall into the confinement container 32 generated in step S3 (step S4). Here, a freefall start position and a component posture of the component CA are set. The freefall start position is set by an X-Y coordinate position indicating a position on an XY-plane, and a Z-coordinate position corresponding to a fall start height level h1 (FIG. 6A). The component posture is set at a rotation angle about each of the X-axis, the Y-axis, and the Z-axis. Thereafter, the unit formative assembly creation part 22 induces a specific number of components CA to freefall into the confinement container 32 under the set freefall condition in accordance with the physical simulation (step S5).

After stabilization of the postures of the components CA induced to have freefallen, the unit formative assembly creation part 22 further removes the confinement container 32, and waits for a lapse of a predetermined standby time after the removal. When the fluctuation in the components CA ceases, creation of one unit formative assembly 3 is completed. Thereafter, the unit formative assembly creation part 22 stores, in the data storage part 25, data of the X-Y position coordinate of each component CA relative to the component group center GC of the created unit formative assembly 3 and the rotation angle of each component about each axis (step S6). The processing of creating the unit formative assembly 3 is executed to create a required number of unit formative assemblies 3.

Next, the component arrangement image creation part 23 sets unit formative assemblies 3 to be arranged in the mixture area 4 (FIG. 4) and the number of unit formative assemblies (step S7). The component arrangement image creation part 23 then sets the mixture area 4 on the physical simulator (step S8). A size of the mixture area 4 is set by using the size of the container area TA and the reduction coefficient α in the aforementioned manner.

Subsequently, the component arrangement image creation part 23 executes arrangement of the unit formative assemblies 3 in the mixture area 4 in a specific formation at a specific rotation angle as exemplified in FIG. 7 (step S9). In this arrangement, the component arrangement image creation part 23 performs a contact check to check an occurrence of contact between the component groups G1 to G4 corresponding to respective unit formative assemblies 3. When the occurrence of contact is confirmed, the component arrangement image creation part 23 shifts or rearranges any one of the component groups G1 to G4 to eliminate the contact (FIGS. 7C and 7D).

Thereafter, the component arrangement image creation part 23 sets the mixture component group area 41 (FIG. 7E) by determining a region including no component CA in the mixture area 4 from an outermost contour for the components and excluding the region (step S10). The component arrangement image creation part 23 then stores, in the data storage part 25, an arrangement coordinate of the component group center GC of each of the component groups G1 to G4 and a rotation angle thereof with reference to the mixture component group center MGC as a reference coordinate (step S11).

The component arrangement image creation part 23 further randomly arranges the mixture component group area 41 in the container area TA as exemplified in FIG. 9 (step S12). The component arrangement image creation part 23 additionally stores, in the data storage part 25, an arrangement coordinate (xn, yn) of the mixture component group center MGC and a rotation angle (On) about the mixture component group center MGC after the arrangement of the mixture component group area 41. Arrangement information thus stored results in true data indicating an arrangement of each component CA in training image data. The component arrangement image creation part 23 stores, in the data storage part 25, an identification serial number of the training image data and true data therefor in association with each other.

Subsequently, the rendering part 24 executes processing of giving a texture to each of the container area TA and the component CA by the physically based rendering. Specifically, the rendering part 24 sets an optical system (camera and lighting) to photograph the container area TA including the components CA arranged therein, and sets a variation range thereof (step S13). The rendering part 24 further sets a material of each of the component CA and the container area TA, and sets a variation range of the material (step S14).

Thereafter, the rendering part 24 executes the physically based rendering to create composite image data or training image data to be the training image 5 (step S15). The created training image data is stored in the data storage part 25 (step S16). The training image data in the data storage part 25 is provided to the learning model generation device 10, if necessary.

### Second Embodiment

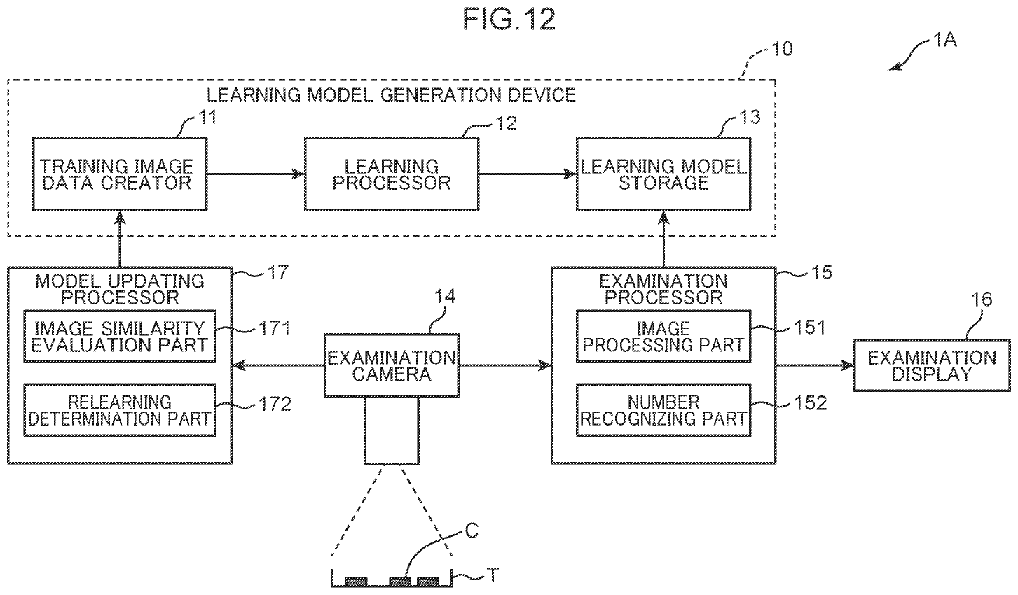

FIG. 12 is a block diagram showing a configuration of an automatic number examining system IA in a second embodiment. The automatic number examining system IA differs from the automatic number examining system 1 in the first embodiment in additionally including a model updating processor 17. The model updating processor 17 compares a training image serving as an original to generate a learning model stored in a learning model storage 13 with an actual image captured by an examination camera 14 in the latest number examination. When a difference is seen between a feature of the training image and a feature of the actual image, the model updating processor 17 causes the learning model generation device 10 to update the learning model.

A tendency of placing a component C in a container T may vary depending on an operator or a robot. For instance, a preceding operator A has an operation tendency of uniformly and dispersedly placing components C in the container T. By contrast, a subsequent operator B who takes over the operation has an operation tendency of densely placing the components C in the container T at a certain position. A learning model currently stored in a learning model storage 13 and having a high number determination accuracy under the operation of the operator A may not have a high number determination accuracy under the operation of the operator B having the different operation tendency. In consideration of the foregoing, the model updating processor 17 periodically determines the accuracy of the learning model.

The model updating processor 17 operatively includes an image similarity evaluation part 171 and a relearning determination part 172. The image similarity evaluation part 171 compares an actual image of the container T accommodating the components C actually captured by the examination camera 14 in an automatic number examination with a training image 5 created by the training image data creator 11, and evaluates an image similarity between the actual image and the training image. The image similarity can be evaluated by a way of, for example, template matching, or can be evaluated by, for example, SWD (Sliced Wasserstein Distance).

The relearning determination part 172 determines, on the basis of a result of the evaluation by the image similarity evaluation part 171, the necessity of updating the learning model, i.e., the necessity of relearning using training image data. When the image similarity is lower than a predetermined threshold, the relearning determination part 172 instructs a learning model generation device 10 to create another training image data reflecting a feature of an actual image currently acquired and update the learning model.

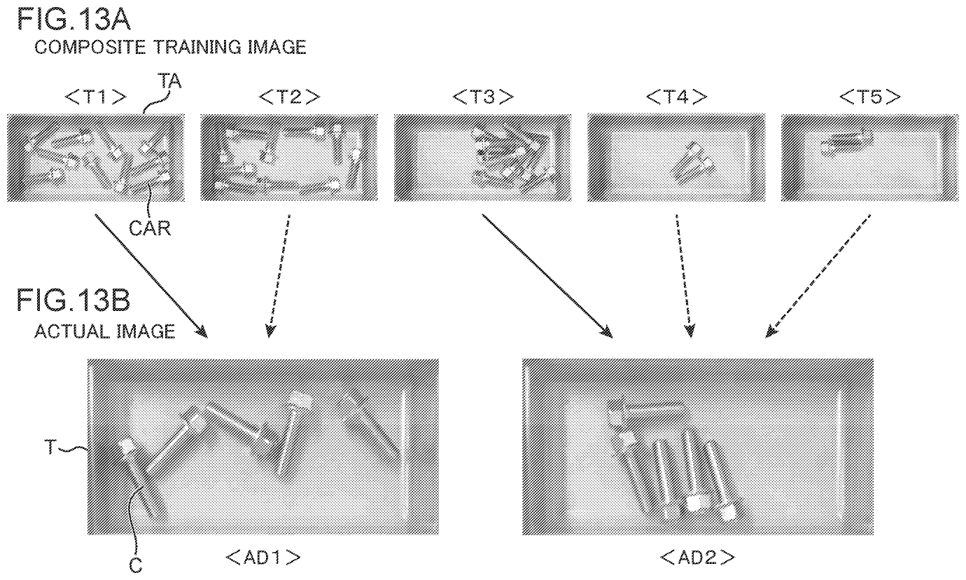

FIGS. 13A and 13B are illustration of a state of determining a similarity between a composite training image and an actual image. FIG. 13A exemplifies five kinds of composite training images T1 to T5. The composite training images T1 to T5 are respectively the same as the training images exemplified in FIGS. 10A to 10E. An actual image AD1 on a left side in FIG. 13B shows components C relatively dispersedly accommodated in the container T. By contrast, an actual image AD2 on a right side shows components C accommodated densely around the center therein.

The composite training image T1 has the highest similarity to the actual image AD1, and the composite training image T2 has the secondly highest similarity thereto among the composite training images T1 to T5. By contrast, each of the composite training images T3, T4, and T5 has a lower similarity to the actual image AD1. The composite training image T3 has the highest similarity to the actual image AD2, and each of the composite training images T4 and T5 has the secondly highest similarity thereto. By contrast, each of the composite training images T1 and T2 has a lower similarity to the actual image AD2.

When an image acquired in an actual number examination has a feature of the actual image AD1, the performance of the learning model is improved through learning of more training images each including the dispersed components like the composite training images T1, T2. When the acquired image has a feature of the actual image AD2, the performance of the learning model is improved through learning of more training images each including the densely arranged components like the composite training images T3 to T5.

For instance, when a feature of an image captured by the examination camera 14 changes from the feature of the actual image AD1 to the feature of the actual image AD2, the model updating processor 17 instructs the learning model generation device 10 to create and relearn a wide variety of composite images reflecting the features of the composite training images T3 to T5, particularly, the feature of the composite training image T3, and update the learning model. According to the second embodiment described heretofore, when a difference between the training image data and the actual image becomes larger as an automatic examination of the number of components actually proceeds, a learning model is updated to conform to the context of an actual situation and have an improved performance.

### Third Embodiment

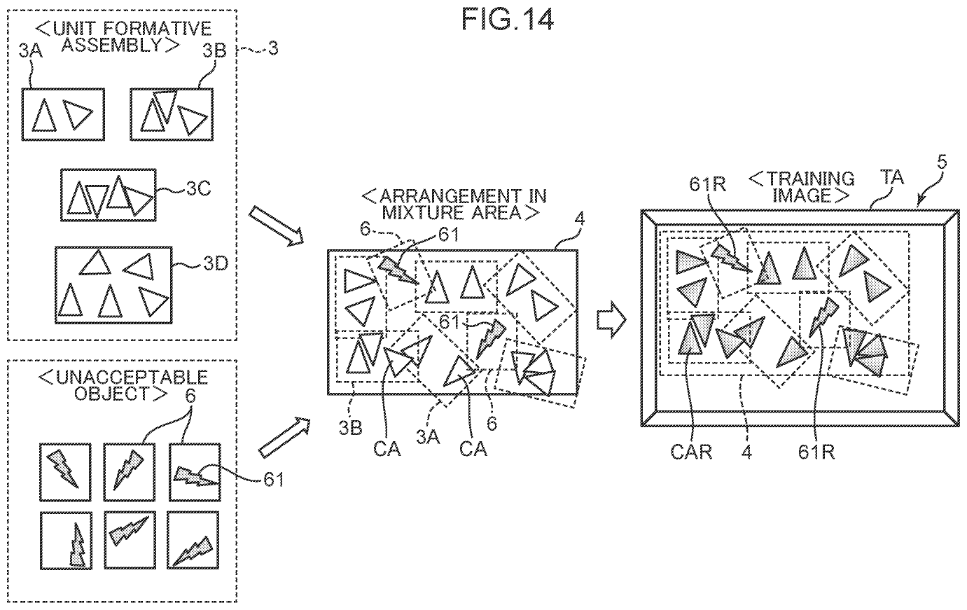

FIG. 14 is a schematic view showing a state of executing a process of creating training image data in a third embodiment. The third embodiment exemplifies creation of training image data showing an unacceptable object in addition to a target component CA. This allows the automatic number examining system 1 to further include operability of examining existence or absence of such an unacceptable object in addition to examining the number of components.

In the third embodiment, at the stage 1 shown in FIG. 3, a training image data creator 11 creates an unacceptable object 61 imitating an actual unacceptable object in the form of three-dimensional data together with a unit formative assembly 3. The unacceptable object 61 is preferably created as a different kind of component which is really likely to mix in a container T accommodating components CA of the unit formative assembly 3. FIG. 14 exemplifies creation of a plurality of unacceptable object blocks 6 each including one unacceptable object 61 by the physical simulator.

In the step of arrangement into a mixture area 4 at the stage 2, the unacceptable object blocks 6 are arranged together with a plurality of unit formative assemblies 3. FIG. 14 exemplifies arrangement of two unacceptable object blocks 6 in the mixture area 4 in addition to two kinds of unit formative assemblies 3A and 3B.

At the subsequent stage 3, shape image data is created by arranging the mixture area 4 including the unacceptable object blocks 6 in a container area TA at a specific position. Further, processing of giving a texture to the shape image data by applying the rendering thereto is executed to create a training image 5. In the training image 5, the unacceptable object 61 is also given a real texture of an actual unacceptable object which is a model, and thus, the component CA and the unacceptable object 61 are respectively represented by a component CAR and an unacceptable object 61R having their respective textures.

Such creation of the training image 5 including the unacceptable object 61R is useful for the examination processor 15 to identify, when an examination target image acquired by the examination camera 14 includes an estimated unacceptable object, the unacceptable object as being mixed in the container T. This succeeds in preventing the container accommodating the unacceptable object mixed with the components C from proceeding to a subsequent step.

### Fourth Embodiment

A fourth embodiment exemplifies simplification of processing of creating shape image data prior to the rendering processing. The first embodiment exemplifies creation of shape image data by arranging unit formative assemblies 3, each created to have components CA induced to have freefallen, in a mixture area 4 in a specific formation, and arranging the mixture area in a container area TA at a specific position. By contrast, the fourth embodiment exemplifies creation of shape image data by inducing a component CA to directly freefall into a container area TA.

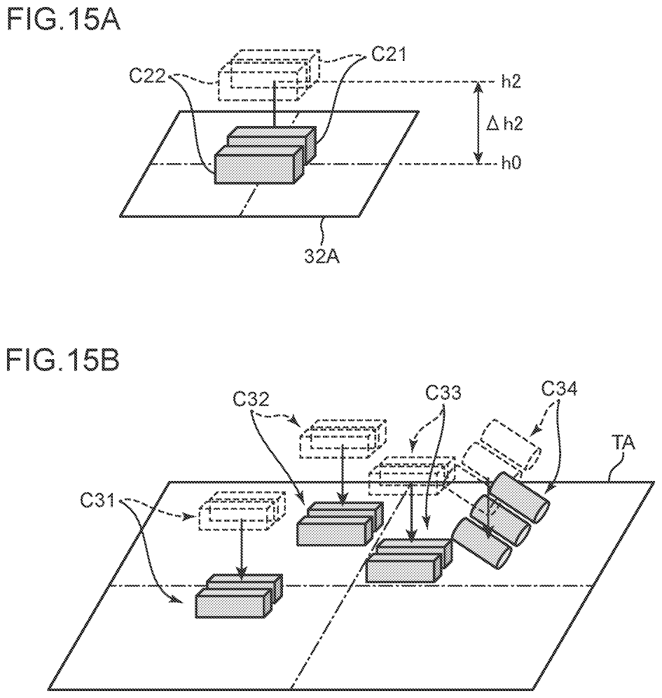

FIG. 15 includes views which are an illustration of a state of executing arrangement of a unit formative assembly 3 in the fourth embodiment. In the first embodiment, the confinement container 32 confines an arrangement area of the component CA induced to freefall. Instead, in the fourth embodiment, a freefall start position is restricted to confine an arrangement area of the component CA. As shown in FIG. 15A, a fall start height level h2 where components C21 and C22 are started to freefall is set to a level higher than a reference height level h0 of a freefall surface 32A by Δh2, i.e., is set to a fall start height level where target objects stay in a specific array.

The fall start height level h2 is lower than the fall start height level h1 shown in FIG. 6A (Δh1>Δh2) to keep an arrangement relationship between the components C21 and C22 from largely fluctuating after abutting of the components to the freefall surface 32A. It is seen from this perspective that freefall of the components C21, C22 in a predefined arrangement relationship therebetween attains arrangement of the components C21, C22 within the range of the freefall surface 32A having the arrangement area shown in FIG. 15A. Thus, the freefall surface 32A can serve as the unit formative assembly 3. Besides, the freefallen components C21, C22 can keep the arrangement relationship they have before the freefall to some extent. Thus, even when the components are induced to directly freefall into the container area TA without the step of arranging the components in the mixture area 4, shape image data having a certain variety of component densities is creatable.

FIG. 15B exemplifies direct freefall of component groups C31, C32, C33, and C34 into the container area TA. A component arrangement relationship among the component groups C31 to C34 is predefined before the freefall, and each of the component groups is induced to freefall from a height position corresponding to the aforementioned fall start height level h2 on the physical simulator. The component arrangement relationship among the component groups C31 to C34 induced to have freefallen substantially remains as the component arrangement relationship they have before the freefall. Shape image data showing components arranged in the container area TA in a specific array is created owing to the freefall. Thereafter, the processing of giving a texture at the stage 3 in FIG. 3 is applied to the shape image data to create training image data.

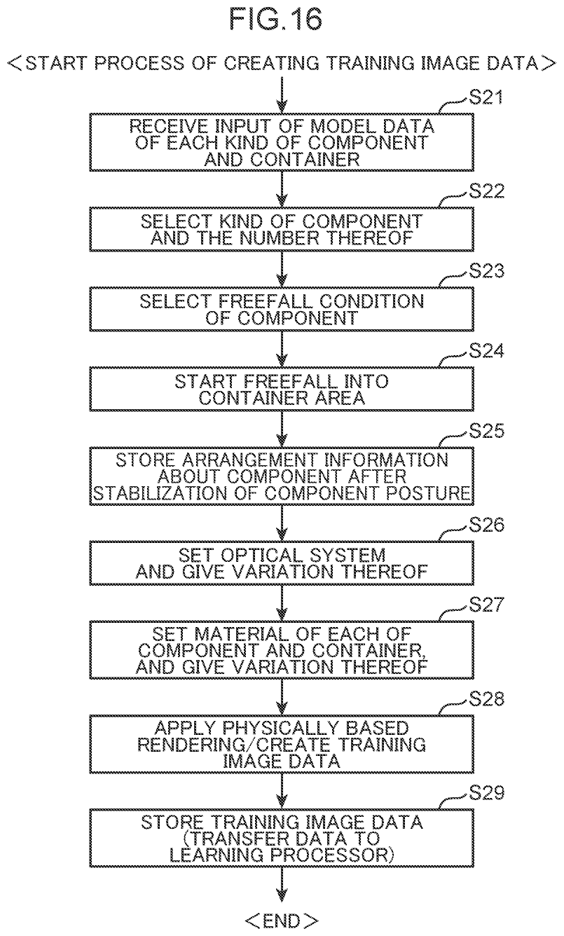

FIG. 16 is a flowchart showing a process of creating training image data in the fourth embodiment. A training image data creator 11 as shown in FIG. 2 creates training image data in this embodiment as well. A processor 2 receives, from a data input part 26, an input of model data representing a three-dimensional shape of each kind of the component C and the container T in an image for creating a composite image to be a training image 5 (step S21). Subsequently, a unit formative assembly creation part 22 selects a kind of and the number of components constituting the component groups C31 to C34 to be created by the physical simulator (step S22).

Next, the unit formative assembly creation part 22 sets a freefall condition of the component groups C31 to C34 selected in step S22 (step S23). Here, a freefall start position and a component posture of each of the component groups C31 to C34 are set. The freefall start position is set by an X-Y coordinate position indicating a position on an XY-plane, and a Z-coordinate position corresponding to the fall start height level h2. The component posture is set at a rotation angle about each of the X-axis, the Y-axis, and the Z-axis.

Thereafter, the unit formative assembly creation part 22 induces the component groups C31 to C34 to freefall into the container area TA under the set freefall condition in accordance with the physical simulation (step S24). After stabilization of the postures of the component groups C31 to C34 induced to have freefallen, the data storage part 25 stores data including the X-Y position coordinate of each component constituting the component group C31 to C34 and a rotation angle of the component about each axis (step S25).

Subsequently, the rendering part 24 executes the processing of giving a texture to each of the container area TA and the component groups C31 to C34 by the physically based rendering (steps S26 to S28). The rendering processing to be executed is the same as the processing described for steps S13 to S15 in FIG. 11, and thus explanation therefor is omitted. The created training image data is stored in the data storage part 25 (step S29).

[Operational Effects]

According to each embodiment described above, pseudo-shape image data as shown in FIGS. 9A and 9B is created by using a container area TA and a component CA created from model data. The shape image data is created by arranging a plurality of unit formative assemblies 3 in a mixture area 4, and arranging a mixture component group area 41 in the container area TA at a specific position. Each of the unit formative assemblies 3 is created by arranging a plurality of components CA in a specific array, and thus, shape image data having various densities or coarseness and fineness of the components CA can be easily composed (the first embodiment). Besides, direct freefall of component groups C31 to C34 into the container area TA as in the fourth embodiment can facilitate composition of the shape image data even with a slight reduction in the variation of component arrangements. Further, data of a training image 5 is created by applying the processing of giving a real texture of each of the container T and the component C to the shape image data. Thus, training image data compatible to an actual image captured by actually photographing the container T accommodating the component C is acquirable. This results in enhancing the performance of a learning model to be generated through machine learning using the training image data.

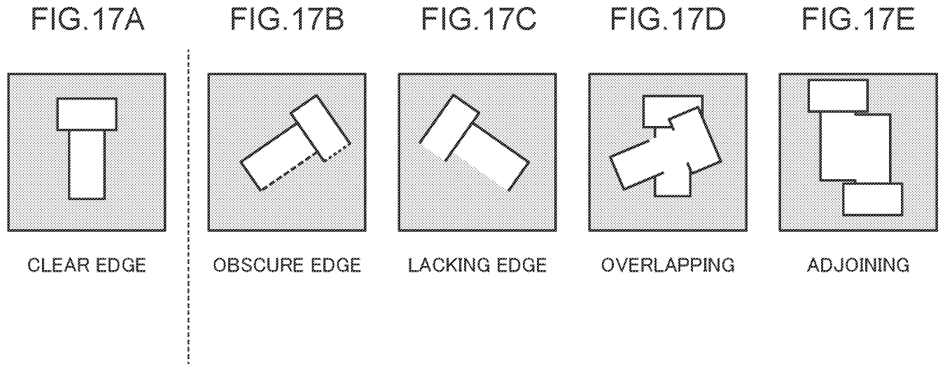

A training image is not created from an actual image but is created through image composition from the beginning, and thus, the created training image data can be more suitable for learning. FIG. 17 includes explanatory views each explaining a defect or failure in the creation of training image data based on an actual image. Image composition is performed on the basis of an acquired two-dimensional actual image to create a training image from the actual image. It is a matter of course that many actual images may be acquired to serve as the training image, but this requires a huge effort for photographing.

Image processing including edge extraction is required to recognize a target object, such as a component, from the two-dimensional image. FIG. 17A shows an image of a target object having a bolt shape, the image being cropped from a certain actual image. In the cropped image, an edge of an original shape of the target object is clearly recognizable. However, in an image including the target object and a background thereof as cropped from the two-dimensional actual image, an edge of the target object is not clearly recognizable in many cases. FIG. 17B shows an example where the edge of the target object is obscure. FIG. 17C shows an example where the edge lacks. In a case where target objects overlap each other or are adjoined to each other, the target objects are seen in a different shape from the original shape. FIG. 17D shows an example of an edge in a case where the target objects overlap each other. FIG. 17E shows an example of an edge in a case where the target objects are adjoined to each other. By contrast, in a three-dimensional composite image like the embodiment, an arrangement relationship between target objects even overlapping each other or adjoined to each other is clearly graspable, not to mention arrangement of a single target object. Therefore, the embodiment achieves creation of training image data appropriately corresponding to true data showing the position of each target object.

[Disclosure Covered by Embodiments]

A learning model generation method for examining the number of target objects according to one aspect of the present disclosure is a method for generating a learning model for use in machine learning to automatically examine the number of target objects accommodated in a container. The method includes: by a device that generates the learning model, a step of inputting model data which represents a shape of the container and a shape of a target object in an image; a step of creating, by using the model data, a plurality of unit formative assemblies each having a plurality of target objects arranged in a specific array and arranging the unit formative assemblies in a container area corresponding to the container in a specific formation to create shape image data of the container accommodating the target objects at a specific density; and a step of creating training image data for use in establishing the learning model by applying processing of giving a real texture of each of the container and the target object to the shape image data.

A learning model generation program for examining the number of target objects according to another aspect of the present disclosure is a program for causing a predetermined learning model generation device to generate a learning model for use in machine learning to automatically examine the number of target objects accommodated in a container. The program includes: causing the learning model generation device to execute: a step of receiving model data which represents a shape of the container and a shape of a target object in an image; a step of creating, by using the model data, a plurality of unit formative assemblies each having a plurality of target objects arranged in a specific array and arranging the unit formative assemblies in a container area corresponding to the container in a specific formation to create shape image data of the container accommodating the target objects at a specific density; and a step of creating training image data for use in establishing the learning model by applying processing of giving a real texture of each of the container and the target object to the shape image data.

According to the method for generating the learning model or the program for generating the learning model, pseudo-shape image data is created by using model data of a container and a target object. The shape image data is created by arranging a plurality of unit formative assemblies in a container area in a specific formation. Each of the unit formative assemblies is created by arranging a plurality of target objects in the container area in a specific array, and thus, shape image data having various densities or coarseness and fineness of the target objects can be easily composed. Further, training image data is created by applying the processing of giving a real texture of each of the container and the target object to the shape image data. Thus, training image data compatible to an actual image captured by actually photographing the container accommodating the target object is acquirable. This results in enhancing the performance of a learning model to be generated through machine learning using the training image data.

In the method for generating the learning model, each of the unit formative assemblies is desirably created by presetting a confined area which is smaller than the container area, and arranging a specific number of the target objects in the confined area in a specific array.

According to the method for generating the learning model, an area of the unit formative assemblies is stylized by the confined area, and thus, arrangement of the unit formative assemblies into the container area thereafter is facilitated.

In the method for generating the learning model, the specific number of the target objects are induced to freefall into the confined area in accordance with a physical simulation to preferably come in the confined area in the specific array.

According to the method for generating the learning model, employing freefall in accordance with the physical simulation is less likely to cause specific dense arrangement of the specific number of the target objects in the confined area. This consequently enables creation of the unit formative assemblies each allowing for various arrangement postures in respective confined areas, and creation of shape image data having various densities, or coarseness and fineness degrees of target objects.

In the method for generating the learning model, the step of creating the shape image data desirably includes: a step of setting a mixture area which is equal to or smaller than the container area and larger than the confined area, and arranging the unit formative assemblies in the mixture area in a specific formation; and a step of arraigning the mixture area including the unit formative assemblies in the container area at a specific position in a specific direction.

According to the method for generating the learning model, the unit formative assemblies are arranged in the mixture area in a specific formation, and the mixture area is then arranged in the container area at a specific position. This enables creation of shape image data having a wider variety of densities, or coarseness and fineness degrees of target objects, for example, creation of shape image data showing target objects dispersed in the container or densely arranged therein.

In the method for generating the learning model, the unit formative assemblies are allowed to freefall from a fall start position where the target objects stay in a specific array into the container area in accordance with a physical simulation to come in the container area in the specific formation.

The method for generating the learning model attains direct arrangement of the unit formative assemblies in the container area in a specific formation while allowing the target objects to stay in the specific array. This can consequently simplify the creation of the shape image data.

The method for generating the learning model desirably further includes: defining information indicating a position of each of the target objects in the shape image data as true data indicating a position of the target object in the training image data; and causing a storage included in the device that generates the learning model to store the training image data and the true data in association with each other.

The method for generating the learning model achieves linkage between a position of each target object in the training image data and corresponding true data more accurately than a way of acquiring the true data on the basis of an actual image.

In the method for generating the learning model, the processing of giving the texture is desirably executed by physically based rendering including: a setting of a photographic optical system for each of the target objects and the container, and a setting of a variation range of the photographic optical system; and a setting of a material of each of the target object and the container, and a setting of a variation range of the material.

The method for generating the learning model succeeds in giving the texture to each of the target object and the container in accordance with a situation of an actual number examination. This consequently enables creation of training image data far more similar to an actual image.

The method for generating the learning model desirably further includes: comparing the training image data with an actual image of the container accommodating the target objects, the actual image being actually acquired in the automatic examination of the number of target objects; and updating the learning model by creating another training image data reflecting a feature of the actual image when a similarity between the training image data and the actual image is lower than a predetermined threshold.

According to the method for generating the learning model, when a difference between the training image data and the actual image becomes larger as an automatic examination of the number of target objects actually proceeds, a learning model is updated to conform to the context of an actual situation and have an improved performance.

In the method for generating the learning model, the step of creating the shape image data desirably includes a step of arranging in the container area an unacceptable object other than the target object.

According to the method for generating the learning model, shape image data showing an unacceptable object is created. The learning model is hence applicable to an examination for existence or absence of an unacceptable object as well as to the number examination.

Conclusively, the present disclosure described heretofore can provide a learning model generation method and a learning model generation program for reliably generating a learning model for use in machine learning to examine the number of target objects.

1. A method for generating a learning model for use in machine learning to automatically examine the number of target objects accommodated in a container, the method comprising:
by a device that generates the learning model,
a step of inputting model data which represents a shape of the container and a shape of a target object in an image;
a step of creating, by using the model data, a plurality of unit formative assemblies each having a plurality of target objects arranged in a specific array and arranging the unit formative assemblies in a container area corresponding to the container in a specific formation to create shape image data of the container accommodating the target objects at a specific density; and
a step of creating training image data for use in establishing the learning model by applying processing of giving a real texture of each of the container and the target object to the shape image data.

2. The method for generating the learning model according to claim 1, wherein each of the unit formative assemblies is created by presetting a confined area which is smaller than the container area, and arranging a specific number of the target objects in the confined area in a specific array.

3. The method for generating the learning model according to claim 2, wherein the specific number of the target objects are induced to freefall into the confined area in accordance with a physical simulation to come in the confined area in the specific array.

4. The method for generating the learning model according to claim 2 or 3, wherein the step of creating the shape image data includes:
a step of setting a mixture area which is equal to or smaller than the container area and larger than the confined area, and arranging the unit formative assemblies in the mixture area in a specific formation; and
a step of arraigning the mixture area including the unit formative assemblies in the container area at a specific position in a specific direction.

5. The method for generating the learning model according to claim 1, wherein the unit formative assemblies are induced to freefall from a fall start position where the target objects stay in a specific array into the container area in accordance with a physical simulation to come in the container area in the specific formation.

6. The method for generating the learning model according to any one of claims 1 to 5, further comprising:
defining information indicating a position of each of the target objects in the shape image data as true data indicating a position of the target object in the training image data; and
causing a storage included in the device that generates the learning model to store the training image data and the true data in association with each other.

7. The method for generating the learning model according to any one of claims 1 to 6, wherein the processing of giving the texture is executed by physically based rendering including:
a setting of a photographic optical system for each of the target objects and the container, and a setting of a variation range of the photographic optical system; and
a setting of a material of each of the target object and the container, and a setting of a variation range of the material.

8. The method for generating the learning model according to any one of claims 1 to 7, further comprising:
comparing the training image data with an actual image of the container accommodating the target objects, the actual image being actually acquired in the automatic examination of the number of target objects; and
updating the learning model by creating another training image data reflecting a feature of the actual image when a similarity between the training image data and the actual image is lower than a predetermined threshold.

9. The method for generating the learning model according to any one of claims 1 to 8, wherein the step of creating the shape image data includes a step of arranging in the container area an unacceptable object other than the target object.

10. A program for causing a predetermined learning model generation device to generate a learning model for use in machine learning to automatically examine the number of objects accommodated in a container, the program comprising:
causing the learning model generation device to execute:
a step of receiving model data which represents a shape of the container and a shape of a target object in an image;
a step of creating, by using the model data, a plurality of unit formative assemblies each having a plurality of target objects arranged in a specific array and arranging the unit formative assemblies in a container area corresponding to the container in a specific formation to create shape image data of the container accommodating the target objects at a specific density; and
a step of creating training image data for use in establishing the learning model by applying processing of giving a real texture of each of the container and the target object to the shape image data.
